(19) United States
(12) Patent Application Publication
(10) Pub. No.: US 2008/0113253 A1
(43) Pub. Date: May 15, 2008

(54) Separator for Polymer Electrolyte Type Fuel Cell and Process for Producing the Same

(75) Inventors: Hiroshi Yagi, Tokyo (JP); Tooru Serizawa, Tokyo (JP); Yasuhiro Uchida, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: DAI NIPPON PRINTING CO., LTD., Shinjuku-ku (JP)

(21) Appl. No.: 11/793,595

(22) PCT Filed: Oct. 17, 2006
(86) PCT No.: PCT/JP06/21000

§ 371 Date: Jun. 21, 2007

(30) Foreign Application Priority Data
Oct. 17, 2005 (JP) 2005-301646
Oct. 17, 2005 (JP) 2005-301647

(51) Int. Cl. H01M 8/02; B32B 15/08

(52) U.S. Cl. 429/38; 428/457

(57) ABSTRACT

A separator comprises a resin layer formed by electrodeposition in such a way as to cover a metal substrate having a groove in at least one surface thereof. The resin layer is composed of an electrically conductive material and a water-repellent material, or the resin layer contains an electrically conductive material, and is designed such that at least a portion of the resin layer positioned at the groove is covered with a water-repellent layer. Consequently, it is possible to provide a separator for a polymer electrolyte type fuel cell, which is less susceptible of flooding, has improved strength and corrosion resistance, and can be fabricated at lower costs.

### ART FIELD

The present invention relates generally to a separator for fuel cells, and more particularly to a separator used between unit cells in a fuel cell built up of a plurality of unit cells stacked one upon another, each comprising a unit cell with electrodes located on both sides of a solid polymer electrolyte membrane, and a fabrication process of the same.

### BACKGROUND ART

Briefly, a fuel cell is a device wherein fuel (a reducing agent) and oxygen or air (an oxidizing agent) are continuously supplied to it from outside for electrochemical reactions through which electric energy is taken out, and classified depending on its working temperature, the type of the fuel used, its applications, etc. Recently developed fuel cells are generally broken down into five types depending primarily on the type of the electrolyte used: a solid oxide type fuel cell, a melt carbonate type fuel cell, a phosphoric acid type fuel cell, a polymer electrolyte type fuel cell, and an alkaline aqueous solution type fuel cell.

These fuel cells use hydrogen gas resulting from methane or the like as fuel. More recently, a direct methanol type fuel cell (sometimes abbreviated as DMFC) relying on direct use as fuel of a methanol aqueous solution has been known in the art, too.

Among others, attention has now been directed to a solid polymer type fuel cell (hereinafter also abbreviated as PEFC) having a structure wherein a solid polymer membrane is held between two electrodes and these components are further sandwiched between separators.

In general, this PEFC has a stacking structure wherein a plurality of unit cells, each having an air electrode (oxygen electrode) and a fuel electrode (hydrogen electrode) on both sides of a solid polymer electrolyte membrane, are stacked one upon another in such a way as to increase its electromotive force depending on what it is used for. A separator interposed between the unit cells is generally provided on its one side with a fuel gas feed groove for feeding fuel to one of the adjoining unit cells, and on another side with an oxidizing agent gas feed groove for feeding an oxidizing agent gas to another of the adjoining unit cells.

At the oxidizing agent gas feed groove for feeding the oxidizing agent gas to the unit cell, however, hydrogen ions passing through the unit cell and oxygen that is the oxidizing agent gas react as schemed below to give out water, which then jams up, causing the so-called “flooding”.

½O₂+2e⁻+2H⁺H₂O

A problem with such flooding is that the flow of the gas in the oxidizing agent gas feed groove is out of order, ending up with a drop of the performance of PEFC.

To get around the aforesaid flooding, for instance, JP-A-9-298064 has come up with a separator wherein a water-repellent layer comprising a gold plated layer, a composite plated layer of gold and carbon fluoride, a fluororesin film or the like is formed on the internal surface of an oxidizing agent gas feed groove, and JP-A-2000-123848 has proposed a separator with a drain groove formed in the bottom wall surface of an oxidizing agent gas feed groove.

However, one problem with the aforesaid separator using gold is an added fabrication cost. Another problem is that it is difficult to form a fluororesin film or the like in conformity with the contour of the oxidizing agent gas feed groove: if an insulating film such as a fluororesin or other film is formed on a portion of the separator other than the oxidizing agent gas feed groove, it will also give rise to a drop of collector's capability.

With the separator with the drain groove formed in the bottom wall surface of the oxidizing agent gas feed groove, on the other hand, a problem is that when there is much water, drain does not timely occur, again leading to flooding.

### DISCLOSURE OF THE INVENTION

An object of the invention is to provide a separator for a polymer electrolyte type fuel cell, which is much less susceptible of flooding, has improved strength and corrosion resistance, and can be fabricated at lower costs as well as a process for the fabrication of that separator.

According to the invention, such an object is accomplished by the provision of a separator arrangement which comprises a metal substrate, a groove formed in at least one surface of said metal substrate, and a resin layer formed by electrodeposition in such a way as to cover said metal substrate, wherein said resin layer contains an electrically conductive material and a water-repellent material.

The invention also provides a separator arrangement which comprises a metal substrate, a groove formed in at least one surface of said metal substrate, and a resin layer formed by electrolytic polymerization in such a way as to cover said metal substrate, wherein said resin layer contains a resin comprising an electrically conductive polymer and further containing a conductivity-improving dopant and a water-repellent material.

Further, the invention provides a separator arrangement which comprises a metal substrate, a groove formed in at least one surface of said metal substrate, and a resin layer formed in such a way as to cover said metal substrate, wherein said resin layer comprises a first resin layer wherein a conductivity-improving dopant and a water-repellent material are contained in a resin comprising an electrically conductive polymer formed by electrolytic polymerization, and a second resin layer formed by electrodeposition in such a way as to cover said first resin layer and containing an electrically conductive material and a water-repellent material.

Further, the invention provides a separator arrangement which comprises a metal substrate, a groove formed in at least one surface of said metal substrate, and a resin layer formed by electrodeposition in such a way as to cover said metal substrate, wherein said resin layer contains an electrically conductive material, and at least a portion of said resin layer positioned at said groove is covered with a water-repellent layer.

Further, the invention provides a separator arrangement which comprises a metal substrate, a groove formed in at least one surface of said metal substrate, and a resin layer formed by electrolytic polymerization in such a way as to cover said metal substrate, wherein said resin layer comprises a resin comprising an electrically conductive polymer and further containing a conductivity-improving dopant, and at least a portion of said resin layer positioned at said groove is covered with a water-repellent layer.

Further, the invention provides a separator arrangement which comprises a metal substrate, a groove formed in at least one surface of said metal substrate, and a resin layer formed in such a way as to cover said metal substrate, wherein said resin layer comprises a first resin layer wherein a conductivity-improving dopant is contained in a resin comprising an electrically conductive polymer formed by electrolytic polymerization, and a second resin layer formed by electrodeposition in such a way as to cover said first resin layer and. containing an electrically conductive material, and at least a portion of said resin layer positioned at said groove is covered with a water-repellent layer.

The invention provides a fabrication process that comprises a step of forming a groove in at least one surface of a metal substrate, and a step of forming a resin layer in such a way as to cover said metal substrate by means of electrodeposition using an electrodeposition solution with an electrically conductive material and a water-repellent material dispersed therein.

Further, the invention provides a fabrication process that comprises a step of forming a groove in at least one surface of a metal substrate, and a step of forming a resin layer by electrolytic polymerization in such a way as to cover said metal substrate, wherein said resin layer comprises a resin comprising an electrically conductive polymer and further containing a conductivity-improving dopant and a water-repellent material.

Further, the invention provides a fabrication process that comprises a step of forming a groove in at least one surface of a metal substrate, a step of forming a first resin layer by electrolytic polymerization in such a way as to cover said metal substrate, wherein said first resin layer comprises a resin comprising an electrically conductive polymer and further containing a conductivity-improving dopant and a water-repellent material, and a step of forming a second resin layer in such a way as to cover said first resin layer by means of an electrodeposition using an electrodeposition solution with an electrically conductive material and a water-repellent material dispersed therein.

Further, the invention provides a fabrication process that comprises a step of forming a groove in at least one surface of a metal substrate, a step of forming a resin layer in such a way as to cover said metal substrate by means of electrodeposition using an electrodeposition solution with an electrically conductive material dispersed therein, and a step of forming a water-repellent layer in such a way as to cover at least a portion of said resin layer positioned at said groove.

Further, the invention provides a fabrication process that comprises a step of forming a groove in at least one surface of a metal substrate, a step of forming a resin layer by electrolytic polymerization in such a way as to cover said metal substrate, wherein said resin layer comprises a resin comprising an electrically conductive polymer and further containing a conductivity-improving dopant, and a step of forming a water-repellent layer in such a way as to cover at least a portion of said resin layer positioned at said groove.

Further, the invention provides a fabrication process that comprises a step of forming a groove in at least one surface of a metal substrate, a step of forming a first resin layer by electrolytic polymerization in such a way as to cover said metal substrate, wherein said first resin layer comprises a resin comprising an electrically conductive polymer and further containing a conductivity-improving dopant, a step of forming a second resin layer in such a way as to cover said first resin layer by means of electrodeposition using an electrodeposition solution with an electrically conductive material dispersed therein, and a step of forming a water-repellent layer in such a way as to cover at least a portion of said second resin layer positioned at said groove.

According to the invention as described above, the resin layer is formed by electrodeposition or electrolytic polymerization; that is, it is uniformly configured in conformity with the contour of the groove, and has high corrosion resistance. Further, because the resin layer contains a water-repellent material or a portion of the resin layer positioned within the groove is covered with a water-repellent layer, water produced by reactions is easily discharged by the oxidizing agent gas to the outside without being jammed up in the groove. In addition, the use of the metal substrate makes sure high strength, and the nonuse of any noble metal makes fabrication cost lower.

Further, the invention provides a separator arrangement that comprises a metal substrate, a groove formed in at least one surface of said metal substrate, and a resin layer formed by electrodeposition in such a way as to cover said metal substrate, wherein said resin layer contains an electrically conductive material, and has water repellency.

Further, the invention provides a separator arrangement that comprises a metal substrate, a groove formed in at least one surface of said metal substrate, and a resin layer formed by electrolytic polymerization in such a way as to cover said metal substrate, wherein said resin layer comprises a resin comprising an electrically conductive polymer and further containing a conductivity-improving dopant, and has water repellency.

Further, the invention provides a separator arrangement that comprises a metal substrate, a groove formed in at least one surface of said metal substrate, and a resin layer formed in such a way as to cover said metal substrate, wherein said resin layer comprises a first resin layer comprising a resin comprising an electrically conductive polymer formed by electrolytic polymerization and further containing a conductivity-improving dopant, and a second resin layer formed by electrodeposition in such a way as to cover said first resin layer, wherein said second resin layer contains an electrically conductive material, and has water repellency.

Further, the invention provides a fabrication process that comprises a step of forming a groove in at least one surface of a metal substrate, and a step of forming a water-repellent resin layer in such a way as to cover said metal substrate by means of electrodeposition using an electrodeposition solution wherein an electrically conductive material is dispersed in a resin having in its structure at least one of an element or functional group for the development of water repellency.

Further, the invention provides a fabrication process which comprises a step of forming a groove in at least one surface of a metal substrate, and a step of forming a water-repellent resin layer by electrolytic polymerization in such a way as to cover said metal substrate, wherein said rein layer comprises a resin comprising an electrically conductive polymer having in its structure at least one of an element or functional group for the development of water repellency and further containing a conductivity-improving dopant.

Further, the invention provides a fabrication process which comprises a step of forming a groove in at least one surface of a metal substrate, a step of forming a first resin layer by electrolytic polymerization in such a way as to cover said metal substrate, wherein said first resin layer comprises a resin comprising an electrically conductive polymer and further containing a conductivity-improving dopant, and a step of forming a water-repellent second resin layer in such a way as to cover said first resin layer by electrodeposition using an electrodeposition solution wherein an electrically conductive material is dispersed in a resin having in its structure at least one of an element or functional group for the development of water repellency.

According to the invention as described above, the resin layer is formed by electrodeposition or electrolytic polymerization; that is, it is uniformly configured in conformity with the contour of the groove, and has high corrosion resistance. Further, because the resin layer is capable of developing water repellency, water produced by reactions is easily discharged by the oxidizing agent gas to the outside without being jammed up in the groove. In addition, the use of the metal substrate makes sure high strength, and the nonuse of any noble metal makes fabrication cost lower.

### BRIEF EXPLANATION OF THE DRAWINGS

FIG. 1 is a partly sectioned view of one embodiment of the separator for a polymer electrolyte type fuel cell according to the invention.

FIG. 2 is a partly sectioned view of another embodiment of the separator for a polymer electrolyte type fuel cell according to the invention.

FIG. 3 is a partly sectioned view of yet another embodiment of the separator for a polymer electrolyte type fuel cell according to the invention.

FIGS. 4A, 4B, 4C and 4D are illustrative of the inventive separator fabrication process with reference to the separator of FIG. 1 as an example.

FIGS. 5A, 5B, 5C and 5D are illustrative of the inventive separator fabrication process with reference to the separator of FIG. 3 as an example.

FIG. 6 is illustrative in partial construction of one exemplary polymer electrolyte type fuel cell using the inventive separator.

FIG. 7 is illustrative of a membrane-electrode assembly that forms a part of the polymer electrolyte type fuel cell depicted in FIG. 6.

FIG. 8 is a perspective view of one state where the separator of the polymer electrolyte type fuel cell depicted in FIG. 6 is spaced away from the membrane-electrode assembly.

FIG. 9 is a perspective view of another state where the separator of the polymer electrolyte type fuel cell depicted in FIG. 6 is spaced away from the membrane-electrode assembly, as viewed in a different direction from that of FIG. 8.

### BEST MODE OF CARRYING OUT THE INVENTION

The present invention is now explained with reference to some embodiments.

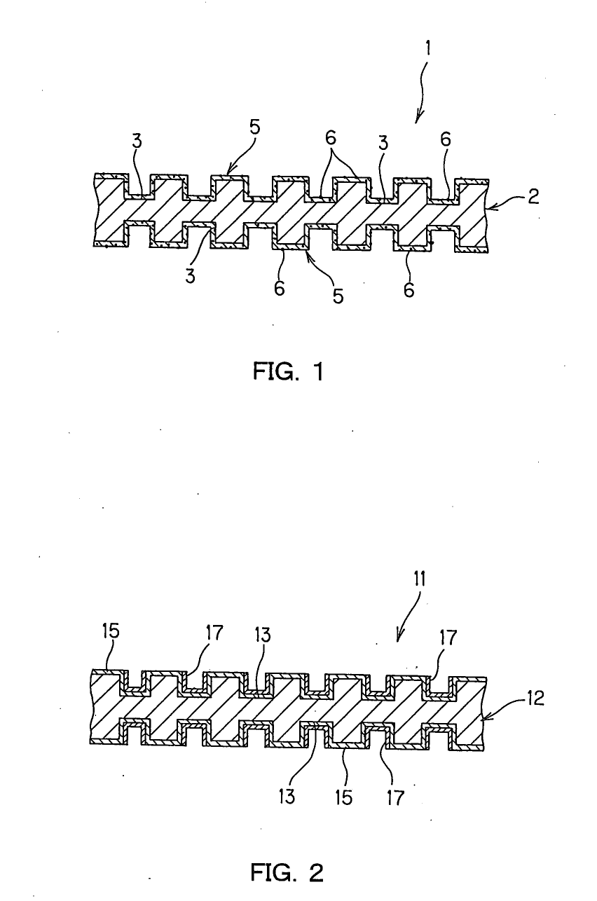

FIG. 1 is a partly sectioned view of one embodiment of the separator for a polymer electrolyte type fuel cell according to the invention. As shown in FIG. 1, a separator 1 of the invention comprises a metal substrate 2, grooves 3 formed in both surfaces of the metal substrate 2, and a resin layer 5 formed by electrodeposition in such a way as to cover both the surfaces of the metal substrate 2. The resin layer 5 here contains an electrically conductive material and a water-repellent material 6. Note here that FIG. 1 shows schematically only the water-repellent material 6 contained in the resin layer 5: it shows nothing about the conductive material.

Preferably, the metal substrate 2 that forms a part of the separator 1 is formed of a material having good electrical conductivity, desired strength, and good processing capability. For instance, stainless, cold-rolled steel sheet, aluminum, titanium and copper are used.

The grooves 3 that the metal substrate 2 has are now explained. When the separator 1 is built in a polymer electrolyte type fuel cell, one of the grooves defines a fuel gas feed groove for feeding fuel gas to one of the adjoining unit cells, and another defines an oxidizing agent gas feed groove for feeding oxidizing agent gas to another of the adjoining unit cells. Alternatively, one of the grooves 3 may provide either of the fuel gas and oxidizing agent gas feed grooves, and another may provide a cooling water groove. Further, one single groove 3 may be formed in only one surface of the metal substrate 2.

No particular limitation is imposed on the configuration of such grooves 3: they may be configured in a continuous zigzag form, comb form, or other form. Likewise, no particular limitation is on depth, width and sectional shape. The metal substrate 2 may also have grooves 3 of different shapes in its front and back surfaces.

The resin layer 5 that forms a part of the separator 1 has electrical conductivity, and is to provide the metal substrate 2 with corrosion resistance and the grooves 3 with water repellency. The resin layer 5 may be formed by dispersing an electrically conductive material and a water repellent material in a variety of anionic or cationic, synthetic polymer resins capable of electrodeposition to prepare an electrodeposition solution, forming it into a film by means of electrodeposition, and curing the film.

The anionic, synthetic polymer resin here, for instance, includes acrylic resin, polyester resin, maleated oil resin, polybutadiene resin, epoxy resin, polyamide resin, and polyimide resin, which may be used alone or in any desired admixture of two or more. These anionic, synthetic polymer resins may also be used in combination with crosslinkable resins such as melamine resin, phenol resin, and urethane resin. On the other hand, the cationic, synthetic polymer resin, for instance, includes acrylic resin, epoxy resin, urethane resin, polybutadiene resin, polyamide resin, and polyimide resin, which may be used alone or in any desired admixture of two or more. These cationic, synthetic polymer resins may also be used in combination with crosslinkable resins such as polyester resin, and urethane resin.

To impart adhesiveness to the aforesaid synthetic polymer resin having electrodeposition capability, adhesiveness-imparting resins such as rosin resin, terpene resin, and petroleum resin may be added to it, if required.

Such synthetic polymer resins having electrodeposition capability are used for electrodeposition while they are neutralized by alkaline or acidic substances in such a way as to be dissolved or dispersed in water. More exactly, the synthetic polymer resin of anionic nature is neutralized by amines such as trimethylamine, diethylamine, dimethylethanolamine, and diisopropanolamine or inorganic alkalis such as ammonia, and caustic potash. The synthetic polymer resin of cationic nature is neutralized by acids such as formic acid, acetic acid, propionic acid, and lactic acid. The neutralized water-soluble polymer resin is used in the form of a water-dispersion type or water-dissolution type while it is diluted by water.

The resin layer 5 formed by electrodeposition may have a thickness of 0.1 to 100 μm, preferably 3 to 30 μm. That the thickness of the resin layer 5 is below 0.1 μm is not preferable, because good enough corrosion resistance cannot often be ensured for the reasons of pinholes or other defects, and a thickness of greater than 100 μm is not preferable, too, because of cracking after solidification by drying, poor productivity, added costs, or other problems.

The electrically conductive material contained in the resin layer 5, for instance, includes carbon materials such as carbon particles, carbon nanotubes, carbon nanofibers, and carbon nanohorns, and corrosion-resistant metals. However, the invention is not necessarily limited to such materials: any other material having the desired acid resistance and electrical conductivity may be used. Fine fiber-form carbon materials such as carbon nanotubes, carbon nanofibers, and carbon nanohorns are found to be best suited for imparting electrical conductivity to the resin layer 5. The resin layer 5 may contain such a conductive material in an appropriate amount determined depending on the conductivity demanded for the resin layer 5, for instance, in an amount of 30 to 90% by weight.

It is here noted that the fine fiber-form carbon materials such as carbon nanotubes, carbon nanofibers, and carbon nanohorns are supposed to be a promising material for various applications such as composite materials, and electronic devices, and when they are used as fillers for composite materials, it is possible to impart their physical properties to the composite materials. For instance, carbon nanotubes are improved in terms of electrical conductivity, acid resistance, processing capability, mechanical strength or the like, so that when used as fillers for composite materials, such carbon nanotubes' improved physical properties may be imparted to the composite materials.

The water-repellent material 6 contained in the resin layer 5, for instance, includes fine particles of a fluorine-containing resin represented by polytetrafluoroethylene (PTFE), and a hydrocarbon resin represented by polyethylene, polypropylene, polyolefin, and polyphenylene as well as fine particles of a metal, inorganic compound, organic resin or the like coated with such resins. Further, use may be made of silica, alumina or other inorganic compound fine particles silane-treated with silane coupling agents containing a methyl group, a long-chain alkyl group, a phenyl group, a perfluoroalkyl group or the like, and fine particles of metals provided on them with a composite plated film by means of electroplating using a plating solution with PTFE dispersed in it. These may be used alone or in any desired combination. Such a water-repellent material 6 has an average particle diameter of 0.1 to 50 μm, preferably 0.5 to 10 μm, and is preferably thinner than the aforesaid resin layer 5. That the water-repellent material 6 has an average particle diameter of less than 0.1 μm is not preferable, because water-repellent particles aggregate together, or are buried in the resin layer 5. An average particle diameter of greater than 50 μm is again not preferable, because the dispersion of the water-repellent material 6 in an electro-deposition solution becomes worse and, hence, the surface roughness of an electrodeposited film grows large. Such a water-repellent material 6 may be partly exposed on the surface of the resin layer 5, as shown. It is here noted that the average particle diameter is measured using a laser diffraction scattering type meter (e.g., MicroTrack Series made by Nikkiso Co., Ltd.) or a dynamic light scattering type meter (e.g., LA-920 made by Horiba Seisakusho Co., Ltd.).

The resin layer 5 may contain such a water-repellent material 6 in an amount large enough to give the desired water repellency to the resin layer 5. For instance, the content of the water-repellent material may be determined in such a way as to let the contact angle of water in the resin layer 5 come within the range of 90° to 150°. It is here noted that the contact angle of water is measured with a commercially available droplet contact angle meter.

In the present invention, the resin layer 5 that forms a part of the separator 1 may just as well be formed of a resin layer obtained by adding a conductivity-improving dopant and a water-repellent material to a resin formed by electrolytic polymerization and composed of an electrically conductive polymer. Electrolytic polymerization is basically a known process wherein currents are passed in an electrolysis solution using an aromatic compound as a monomer with electrodes dipped in it, thereby electrochemically effecting oxidization or reduction for polymerization. The incorporation of the dopant in the resin layer may be carried out by electrical doping wherein the dopant is incorporated in the resin layer at the time of electrolytic polymerization, or liquid-phase doping wherein an electrically conductive polymer is dipped in a dopant liquid or a solution containing dopant molecules after electrolytic polymerization. The dopant here, for instance, includes a donor type dopant such as an alkaline metal, and alkylammonium ions, and an acceptor type dopant such as halogens, Lewis acid, protonic acid, transition metal halides, and organic acids.

The content of the dopant in the resin layer 5 may be properly determined depending on the electrical conductivity that the resin layer 5 must have.

Further in the present invention, the resin layer 5 that forms a part of the separator 1 may have a composite film structure comprising a first resin layer containing a resin formed by electrolytic polymerization of an electrically conductive polymer with a conductivity-improving dopant and a water-repellent material added to it, and a second resin layer formed by electrodeposition in such a way as to cover the first resin layer and containing a conductive material and a water-repellent material.

FIG. 2 is a partly sectioned view of another embodiment of the separator for a polymer electrolyte type fuel cell according to the invention. As shown in FIG. 2, a separator 11 of the invention comprises a metal substrate 12, grooves 13 formed in both surfaces of the metal substrate 12, and a resin layer 15 formed by electrodeposition in such a way as to cover both the surfaces of the metal substrate 12. The resin layer 15 here contains an electrically conductive material, and portions of the resin layer 15 positioned at the grooves 13 are covered with a water-repellent layer 17.

The metal substrate 12 that forms a part of the separator 11 may be formed of a material similar to that of the metal substrate 2 forming a part of the aforesaid separator 1.

The grooves 13 that the metal substrate 12 has, too, may be similar to those in the aforesaid metal substrate 2. Accordingly, no particular limitation is imposed on the configuration of such grooves 13: they may be configured in a continuous zigzag form, comb form, or other form. Likewise, no particular limitation is on depth, width and sectional shape. The grooves 13 in the front and back surfaces of the metal substrate 12 may have different shapes.

The resin layer 15 that forms a part of the separator 11 has electrical conductivity, and is to provide the metal substrate 12 with corrosion resistance. To form this resin layer 15, an electrodeposition solution with a conductive material dispersed in any one of various synthetic polymer resins of anionic or cationic nature and capable of electrodeposition may be formed by electrodeposition into a film. And thereafter, that film is cured.

For the synthetic polymer resins of anionic and cationic nature, those mentioned with reference to the aforesaid resin layer 5 may just as well be used, optionally in combination with crosslinkable resins. If required, an adhesiveness-imparting resin such as rosin resin, terpene resin, and petroleum resin may be added to the synthetic polymer resin capable of electrodeposition, thereby imparting adhesiveness to it. As is the case with the formation of the aforesaid resin layer 5 by electrodeposition, the synthetic polymer resin capable of electrodeposition is used for electrodeposition while it is neutralized by an alkaline or acidic substrate into a water-soluble or water dispersion state.

The resin layer 15 formed by electrodeposition may have a thickness of 0.1 to 100 μm, preferably 3 to 30 μm. That the thickness of the resin layer 15 is below 0.1 μm is not preferable, because good enough corrosion resistance cannot often be ensured for the reasons of pinholes or other defects, and a thickness of greater than 100 μm is not preferable, too, because of cracking after solidification by drying, poor productivity, added costs, or other problems.

For the electrically conductive material contained in the resin layer 15, those already described as being contained in the aforesaid resin layer 5 may be used. The resin layer 15 may contain such a conductive material in an appropriate amount determined depending on the conductivity demanded for the resin layer 15, for instance, in an amount of 30 to 90% by weight.

The water-repellent layer 17 to cover the resin layer 15 positioned at each groove 13 is provided to impart water repellency to that groove, and may be formed of a binder with a water-repellent material contained in it. For the water-repellent material used, those described with reference to the aforesaid water-repellent material 6 may be used alone or in any desired combination. For the binder, there is the mention of sodium salts of formalin condensates of β-naphthalenesulfonic acid, polyoxyethylenenonylphenyl ether, polyoxyethylene derived polyethylene, sodium salts of polyethylene oxide-base polycarboxylic acid, a special carboxylic acid type polymer surfactant, etc., which may be used alone or in any desired combination.

The resin layer 15 may be covered with the water-repellent layer 17 at a thickness and amount large enough to enable it to bring about the desired water repellency. For instance, the thickness and amount of the water-repellent layer 17 may be determined in such a way as to let the contact angle of water in the water-repellent layer 17 come within the range of 90° to 150°. As an example, the thickness of the water-repellent layer 17 may be within the range of 0.1 to 100 nm, preferably 1 to 10 nm.

In the example illustrated, only the portion of the resin layer 15 positioned at each groove 13 is covered with the water-repellent layer 17, and the water-repellent layer 17 is not formed on the rest: when the separator 11 is built in a polymer electrolyte type fuel cell, the conductive resin layer 15 is in direct contact with the membrane-electrode assembly (MEA) to be described later, so that improved collector capability is achievable. It is here to be understood that the separator 11 may have the entire surface of the resin layer 15 covered with the water-repellent layer 17. However, it is then preferable that at the step of incorporating the separator 11 in a polymer electrolyte type fuel cell, the water-repellent layer 17 comes off at a site except each groove 13, allowing the conductive resin layer 15 to be in direct contact with the membrane-electrode assembly (MEA).

Alternatively, the water-repellent layer 17 may be formed on the resin layer 15 in archipelagic configuration. In this case, to what magnitude and degree the resin layer 15 is covered with the archipelagic water-repellent layer 17 may be such that the contact angle of water in each groove 13 comes within the range of 90° to 150°.

It is here noted that the resin layer 15 that forms a part of the separator 11 may be a resin layer containing a resin formed by electrolytic polymerization of an electrically conductive polymer, with a conductivity-improving dopant added to it.

Further in the present invention, the resin layer 15 that forms a part of the separator 11 may have a composite film structure comprising a first resin layer containing a resin formed by electrolytic polymerization of an electrically conductive polymer with a conductivity-improving dopant added to it, and a second resin layer formed by electrodeposition in such a way as to cover the first resin layer and containing an electrically conductive material.

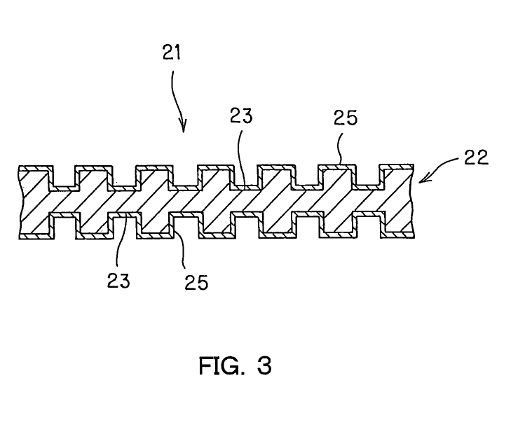

FIG. 3 is a partly sectioned view of yet another embodiment of the separator for a polymer electrolyte type fuel cell according to the invention. As shown in FIG. 3, a separator 21 of the invention comprises a metal substrate 22, grooves 23 formed in both surfaces of the metal substrate 22, and a resin layer 25 formed by electrodeposition in such a way as to cover both the surfaces of the metal substrate 22′. The resin layer 25 here contains an electrically conductive material, and has water repellency.

The metal substrate 22 that forms a part of the separator 21 may be formed of a material similar to that of the metal substrate 2 forming a part of the aforesaid separator 1.

The grooves 23 that the metal substrate 22 has, too, may be similar to those in the aforesaid metal substrate 2. Accordingly, no particular limitation is imposed on the configuration of such grooves 23: they may be configured in a continuous zigzag form, comb form, or other form. Likewise, no particular limitation is on depth, width and sectional shape. The grooves 23 in the front and back surfaces of the metal substrate 22 may have different shapes.

The resin layer 25 that forms a part of the separator 21 has electrical conductivity and water repellency, and is to provide the metal substrate 22 with corrosion resistance. To form this resin layer 25, an electrodeposition solution with a conductive material dispersed in any one of various synthetic polymer resins of anionic or cationic nature capable of electrodeposition and having in its structure an element or functional group for the development of water repellency is formed by electrodeposition into a film. And thereafter, that film is cured.

For the element contained in the resin layer 25 for the development of water repellency, for instance, fluorine, and silicon is mentioned. For the functional group for the development of water repellency, for instance, there is the mention of alkyl groups such as methyl, ethyl, propyl, n-butyl, isobutyl, hexyl, octyl, decyl, and lauryl.

For the anionic synthetic polymer resin having in its structure an element or function group for the development of water repellency, there is the mention of acrylic resin, polyester resin, maleated oil resin, polybutadiene resin, epoxy resin, polyamide resin, polyimide resin and so on, which may be used alone or in any desired admixture of two or more. Such anionic synthetic polymer resin may also be used in combination with crosslinkable resin such as melamine resin, phenol resin, and urethane resin.

For the cationic synthetic polymer resin having its structure an element or functional group for the development of water repellency, on the other hand, there is the mention of acrylic resin, epoxy resin, urethane resin, polybutadiene resin, polyamide resin, polyimide resin and so on, which may be used alone or in any desired admixture of two or more. Such cationic synthetic polymer resin may also be used in combination with crosslinkable resin such as polyester resin, and urethane resin.

To impart adhesiveness to the aforesaid synthetic polymer resin having electrodeposition capability, adhesiveness-imparting resin such as rosin resin, terpene resin, and petroleum resin may be added to it, if required.

Such synthetic polymer resin having electrodeposition capability are used for electrodeposition while it is neutralized by alkaline or acidic substances in such a way as to be dissolved or dispersed in water. More exactly, the synthetic polymer resin of anionic nature is neutralized by amines such as trimethylamine, diethylamine, dimethylethanolamine, and diisopropanolamine or inorganic alkalis such as ammonia, and caustic potash. The synthetic polymer resin of cationic nature is neutralized by acids such as formic acid, acetic acid, propionic acid, and lactic acid. The neutralized water-soluble polymer resin is used in the form of a water-dispersion type or water-dissolution type while it is diluted by water.

For the conductive material contained in the resin layer 25, those contained in the resin layer 5 of the aforesaid separator 1 may be used. The resin layer 25 may contain such a conductive material in an appropriate amount determined depending on the conductivity demanded for the resin layer 25, for instance, in an amount of 30 to 90% by weight.

The water repellency of such resin layer 25 is preferably such that the contact angle of water comes within the range of 90° to 150°. It is here noted that the contact angle of water is measured using a commercially available droplet contact angle meter. Such resin layer 25 has a thickness in the range of 0.1 to 100 μm, preferably 3 to 30 μm. That the thickness of the resin layer 25 is below 0.1 μm is not preferable, because good enough corrosion resistance cannot often be ensured for the reasons of pinholes or other defects, and a thickness of greater than 100 μm is not preferable, too, because of cracking after solidification by drying, poor productivity, added costs, or other problems.

In the present invention, the resin layer 25 that forms a part of the separator 21 may just as well be formed of a resin layer of an electrically conductive polymer having in its structure an element or function group for the development of water repellency, obtained by adding a conductivity-improving dopant to a resin formed by electrolytic polymerization of an electrically conductive polymer. Electrolytic polymerization is basically a known process wherein currents are passed in an electrolysis solution using an aromatic compound as a monomer with electrodes dipped in it, thereby electrochemically effecting oxidization or reduction for polymerization. The incorporation of the dopant in the resin layer may be carried out by electrical doping wherein the dopant is incorporated in the resin layer at the time of electrolytic polymerization, or liquid-phase doping wherein an electrically conductive polymer is dipped in a dopant liquid or a solution containing dopant molecules after electrolytic polymerization. The dopant here, for instance, includes a donor type dopant such as an alkaline metal, and alkylammonium ions, and an acceptor type dopant such as halogens, Lewis acid, protonic acid, transition metal halides, and organic acids.

The content of the dopant in the resin layer 25 may be properly determined depending on the electrical conductivity that the resin layer 25 must have.

Further in the present invention, the resin layer 25 that forms a part of the separator 21 may have a composite membrane structure comprising a first resin layer containing a resin formed by electrolytic polymerization of an electrically conductive polymer with a conductivity-improving dopant added to it, and a second resin layer formed by electrodeposition in such a way as to cover the first resin layer and containing a conductive material and having water repellency.

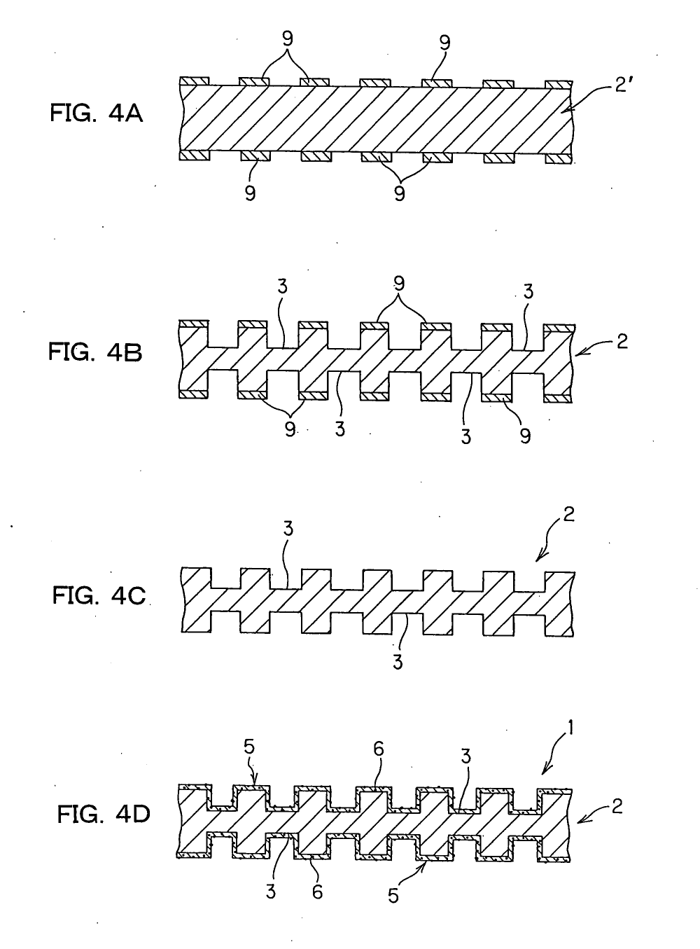

FIGS. 4A, 4B, 4C and 4D are illustrative of how to fabricate the separator of the invention as described above, taking the separator 1 of FIG. 1 as an example. First, resists 9, 9 are formed on both surfaces of a metal sheet material 2′ in a desired pattern by means of photolithography (FIG. 4A). Using such resists 9, 9 as a mask, the metal sheet material 2′ is etched from both its surfaces to form the grooves 3, 3 (FIG. 4B). Thereafter, the resists 9, 9 are stripped off to obtain the metal substrate 2 (FIG. 4C). On both surfaces of the metal substrate 2, there are films formed by electrodeposition using an electrodeposition solution capable of electrodeposition with an electrically conductive material and a water-repellent material dispersed in any one of various anionic, or cationic synthetic polymer resins, and the films are thereafter cured into the resin layer 5 (FIG. 4D). The thus formed resin layer 5 has good electrical conductivity and high corrosion resistance plus water repellency. In this way, the separator 1 is obtained.

In the fabrication of the separator 11 of FIG. 2, the steps up to the preparation of the metal substrate 12 having the grooves 13, 13 are carried out as in the fabrication of the aforesaid metal substrate 2. Then, on both surfaces of the metal substrate 12, there are films formed by electrodeposition using an electrodeposition solution with an electrically conductive material dispersed in any one of various anionic, or cationic synthetic polymer resins capable of electrodeposition, and the films are thereafter cured into the resin layer 15. The thus formed resin layer 15 has good electrical conductivity plus high corrosion resistance. Then, a mask is formed on a site except the grooves 13, 13 by means of photolithography, a film is formed on the site of the resin layer 15 positioned at the grooves 13, 13 by means of a spray, dipping or other like process using a coating solution with a water-repellent material contained in a binder, and the film is thereafter cured into a water-repellent layer 17. Alternatively, the water-repellent layer 17 may be formed by means of a CVD, sputtering or other like process, using the aforesaid mask. The thus formed water-repellent layer 17 has water repellency. Then, as the aforesaid mask is removed, there is the separator 11 obtained.

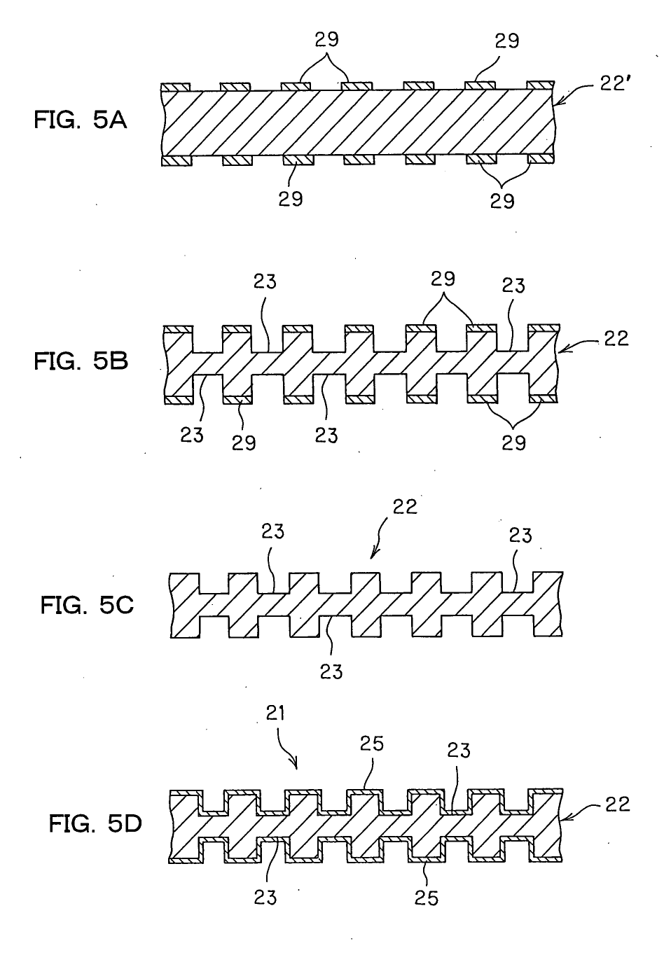

FIGS. 5A, 5B, 5C and 5D are illustrative of how to fabricate the separator of the invention, taking the separator 21 of FIG. 3 as an example. First, resists 29, 29 are formed on both surfaces of a metal sheet material 22′ in a desired pattern by means of photolithography (FIG. 5A). Using such resists 29, 29 as a mask, the metal sheet material 22′ is etched from both its surfaces to form grooves 23, 23 (FIG. 5B). Thereafter, the resists 29, 29 are stripped off to obtain the metal substrate 22 (FIG. 4C). On both surfaces of the metal substrate 22, there are films formed by electrodeposition using an electrodeposition solution wherein an electrically conductive material and at least one of substances including an element for the development of water repellency or a functional group for the development of water repellency are dispersed in any one of various anionic, or cationic synthetic polymer resins capable of electrodeposition, and the films are thereafter cured into the resin layer 25 (FIG. 5D). An electrodeposition solution wherein an electrically conductive material is dispersed in a synthetic polymer resin having in its structure an element or functional group for the development of water repellency may just as well be used for the electrodeposition solution here. Further, an electrodeposition solution wherein a substance including an element for the development of water repellency or a functional group for the development of water repellency and an electrically conductive material are dispersed in a synthetic polymer resin having in its structure an element or function group for the development of water repellency, too, may be used. The thus formed resin layer 25 has good electrical conductivity and high corrosion resistance plus water repellency. In this way, there is the separator 21 obtained.

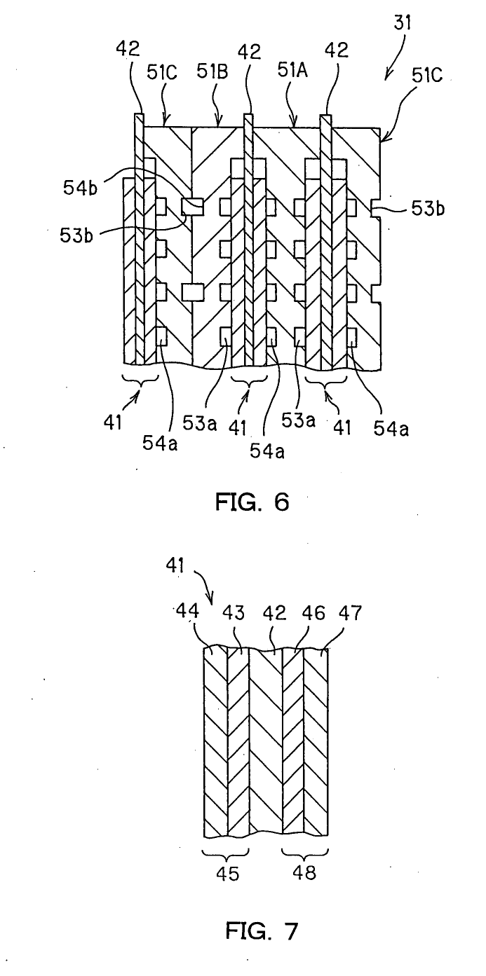

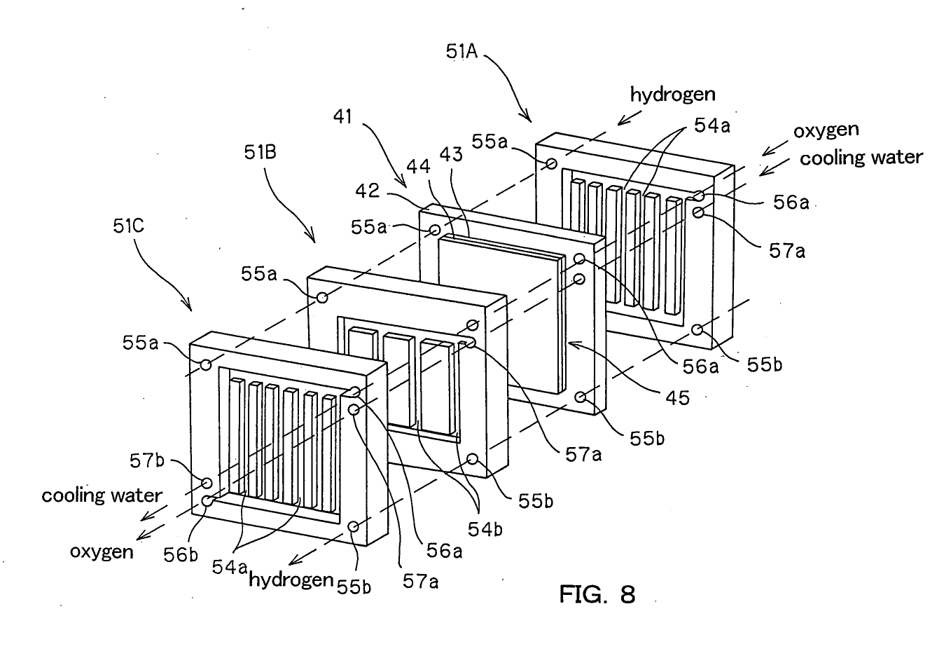

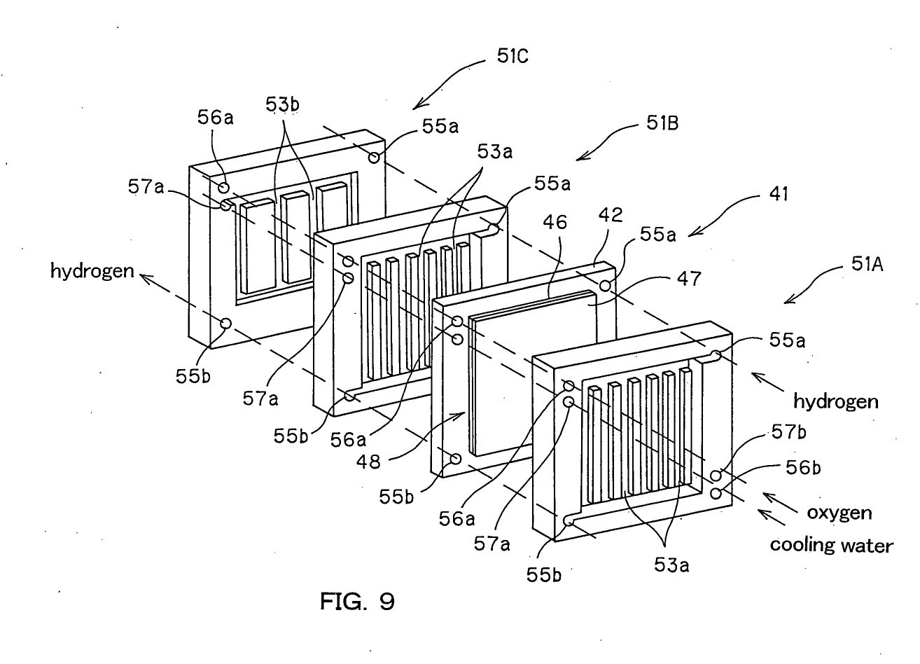

One example of the polymer electrolyte type fuel cell using the separator of the invention is now explained with reference to FIGS. 6, 7, 8 and 9. FIG. 6 is illustrative in fragmental construction of the structure of the polymer electrolyte type fuel cell; FIG. 7 is illustrative of a membrane-electrode assembly that forms a part of the polymer electrolyte type fuel cell; and FIGS. 8 and 9 are perspective views of states where the separator of the polymer electrolyte type fuel cell is spaced away from the membrane-electrode assembly, as viewed from different directions.

In FIGS. 6-9, a polymer electrolyte type fuel cell 31 is built up of a membrane-electrode assembly (MEA) 41 and a separator 51.

As shown in FIG. 7, the MEA 41 has a fuel electrode (hydrogen electrode) 45 comprising a catalyst layer 43 and a gas diffusion layer (GDL) 44 located on one surface of a polymer electrolyte membrane 42 and an air electrode (oxygen electrode) 48 comprising a catalyst layer 46 and a gas diffusion layer (GDL) 47 located on another surface of the polymer electrolyte membrane 42.

The separator 51 is made up of a separator element 51A comprising a fuel gas feed groove 53a in one surface and an oxidizing agent gas feed groove 54a in another surface, a separator element 51B comprising a fuel gas feed groove 53a in one surface and a cooling water groove 54b in another surface, and a separator element 51C comprising a cooling water groove 53b in one surface and an oxidizing agent gas feed groove 54a in another surface. Such separator elements 51A, 51B and 51C define together the separator of the invention that has on both its surfaces such resin layer 5 as shown in FIG. 1, such resin layer 15 and water-repellent layer 17 as shown in FIG. 2, or such resin layer 25 as shown in FIG. 3, although not left out in FIGS. 6-9. Note here that the separator 51B having no oxidizing agent gas feed groove 54a may be a separator that is covered with a resin layer possessing no water repellency to impart electrical conductivity and corrosion resistance to it, i.e., the separator standing outside of the invention.

At given positions of each separator element 51A, 51B, 51C and the aforesaid polymer electrolytic membrane 42, there are two fuel gas inlet holes 55a, 55b, two oxidizing agent gas inlet holes 56a, 56b, and two cooling water inlet holes 57a, 57b, all in through-hole configuration. And then, the respective separator elements 51A, 51B, 51C and the MEA 41 that is a unit cell are stacked together such that the air electrode (oxygen electrode) 48 of the MEA 41 is in engagement with the surface of the separator element 51A having the oxidizing agent gas feed groove 54a formed in it, the fuel electrode (hydrogen electrode) 45 of the MEA 41 is in engagement with the surface of the separator 51B having the fuel gas feed groove 53a formed in it, and the surface of the separator element 51B having the cooling water groove 54b formed in it is in engagement with the surface of the separator element 51C having the cooling water groove 53b formed in it, and this stacking operation is repeated to set up a polymer electrolyte type fuel cell 31. In such a stacked state, the aforesaid two fuel gas inlet holes 55a, 55b define fuel gas feed passages that extend through in the stacking direction; the two oxidizing agent gas inlet holes 56a, 56b define oxidizing agent gas feed passages that extend through in the stacking direction; and the two cooling water inlet holes 57a, 57b define cooling water feed passages that extend through in the staking direction.

The aforesaid embodiments of the invention are given for the purpose of exemplification alone: the invention is in no sense limited to them.

The present invention is now explained in more details with reference to more specific examples.

### EXAMPLE 1

A 4.5 mm thick stainless sheet (SUS304) was provided as a metal sheet material, and then decreased on each surface.

Then, a 20 μm thick coating film was formed on each surface of that stainless sheet by dip coating of a photosensitive material (a mixture of casein with ammonium bichromate). The coating film was exposed to light (by a 60-second irradiation with light from a 5 kW mercury lamp) using a photomask, and developed (by spraying of a 40° C. warm water) to form a resist.

Then, ferric chloride heated to 70° C. was sprayed onto both surfaces of the stainless sheet through the aforesaid resist to effect half-etching down to a given depth. Then, an aqueous solution of caustic soda at 80° C. was used to strip the resist off, after which the stainless sheet was then rinsed to thereby obtain a metal substrate having a 1-mm wide, 0.5-mm deep groove of almost semi-circular shape in section that meandered a length of 1,000 mm at an amplitude of 100 mm and a pitch of 50 mm.

On the other hand, an epoxy electrodeposition solution was prepared as follows.

First, while 1,000 parts by weight of diglycidyl ether of bisphenol A (having an epoxy equivalent of 910) were kept at 70 under agitation, 463 parts by weight of ethylene glycol monoethyl ether were dissolved in it with a further addition of 80.3 parts by weight of diethylamine for a 2-hour reaction at 100° C., thereby preparing an amine-epoxy adduct (A).

Apart from this, 0.05 part by weight of dibutyltin laurate was added to 875 parts by weight of Colonate L (Nippon Polyurethane Co., Ltd., diisocyanate: 13% of NCO, 75% by weight of nonvolatile matter), which were then heated to 50° C. for the addition of 390 parts by weight of 2-ethyl-hexanol, whereupon they were allowed to react at 120° C. for 90 minutes. The obtained reaction product was diluted with 130 parts by weight of ethylene glycol monoethyl ether to obtain a component (B).

Then, a mixture of 1,000 parts by weight of the aforesaid amine-epoxy adduct (A) and 400 parts by weight of the component (B) was neutralized with 30 parts by weight of glacial acetic acid, and thereafter diluted with 570 parts by weight of deionized water to prepare a resin A with 50% by weight of nonvolatile matter. An epoxy electrodeposition solution was prepared by blending together 200.2 parts by weight of the resin A (with the content of the resinous component being 86.3 by volume), 583.3 parts by weight of deionized water and 2.4 parts by weight of dibutyltin laurate.

Then, added to, and dispersed in, the aforesaid epoxy electrodeposition solution were an electrically conductive material, i.e., carbon nanotubes (gas-phase process carbon fibers VGCF made by Showa Denko Co., Ltd.) in an amount of 60% by weight with respect to the resin solid matter and a water-repellent material, i.e., polytetrafluoroethylene fine particles (Fluon made by Asahi Glass; Co., Ltd.) in an amount of 10% by weight with respect to the resin solid matter to obtain an electrodeposition solution.

While the aforesaid electrodeposition solution was held at 20° C. under agitation, the aforesaid metal substrate was dipped in that solution for a one-minute electrodeposition at an inter-electrode distance of 40 mm and a voltage of 50 V. The metal substrate was then pulled up and rinsed with purified water, after which the metal substrate was dried on a hotplate at 150° C. for 3 minutes, followed by heat curing treatment at 180° C. for 1 hour in a nitrogen atmosphere. As a result, there was a separator obtained, in which the metal substrate plus the grooves was provided thereon with a resin layer having a uniform thickness of 15 μm.

As a result of measurement of the contact angle of water in the resin layer of that separator according to the method mentioned below, it was found to 110°, indicative of high water repellency.

Measurement of the Contact Angle of Water

Purified water was added dropwise at normal temperature and pressure onto the surface of the sample to be measured to obtain direct readings of the height h of the vertex and the radius a of the droplet. An angle θB made by a solid-liquid interface-horizontal and a line connecting the vertex of the droplet is half the contact angle θA: the contact angle of water is found from θA=2 θB=2 arctan(h/a).

### EXAMPLE 2

As in Example 1, a metal substrate having grooves was prepared.

An epoxy electrodeposition solution was prepared, too, as in Example 1. An electrically conductive material, i.e., carbon black (Vulcan XC-72 made by Cabot Co., Ltd.) was dispersed in that epoxy electrodeposition solution in an amount of 75% by weight with respect to the resin solid matter to obtain an electrodeposition solution.

Using the aforesaid electrodeposition solution, electrodeposition, rinsing and curing were carried out under the same conditions as in Example 1 to provide a resin layer having a uniform thickness of 15 μm on the metal substrate plus grooves.

Then, a photosensitive resist (THB Resist made by JSR Co., Ltd.) was coated by spin coating onto the resin layer, following which the photosensitive resist was exposed to light (by a 30-second irradiation with light from a 5 kW mercury lamp) using a photomask having light blocks corresponding to the grooves in the metal substrate, and developed (by spraying of a THB developer made by JSR Co., Ltd.), whereby a mask was formed on the resin layer of the metal substrate minus the grooves.

Then, a water-repellent layer comprising a fluorinated resin was formed by a CVD process by way of the aforesaid mask, after which the mask was removed off using a THB stripper made by JSR Co., Ltd. In this way, there was a separator obtained, which had a water-repellent layer (of 5 nm in thickness) on the resin layer in the grooves.

As a result of measurement as in Example 1, the contact angle of water in the water-repellent layer of that separator was found to be 120°, indicating that there was high water repellency obtained.

Likewise, the contact angle of water in the resin layer with no water-repellent layer formed on it was measured as in Example 1. As a consequence, the contact angle of water was found to be 60°, indicating that there was very low water repellency obtained.

### EXAMPLE 3

A metal substrate having grooves was prepared as in Example 1.

On the other hand, a water-repellent acryl-epoxy electrodeposition solution was prepared as described below.

First, while 1,000 parts by weight of diglycidyl ether of bisphenol A (having an epoxy equivalent of 910) were kept at 70° C. under agitation, 463 parts by weight of ethylene glycol monoethyl ether were dissolved in it with a further addition of 80.3 parts by weight of diethylamine for a 2-hour reaction at 100° C., thereby preparing an amine-epoxy adduct (A).

Apart from this, 0.05 part by weight of dibutyltin laurate was added to 875 parts by weight of Colonate L (Nippon Polyurethane Co., Ltd., diisocyanate: 13% of NCO, 75% by weight of nonvolatile matter), which were then heated to 50 for the addition of 390 parts by weight of 2-ethyl-hexanol, whereupon they were allowed to react at 120° C. for 90 minutes. The obtained reaction product was diluted with 130 parts by weight of ethylene glycol monoethyl ether to obtain a component (B).

Then, a mixture of 1,000 parts by weight of the aforesaid amine-epoxy adduct (A) and 400 parts by weight of the component (B) was neutralized with 30 parts by weight of glacial acetic acid and diluted with 570 parts by weight of deionized water to prepare a resin A with 50% by weight of nonvolatile matter. A water-repellent acryl-epoxy electrodeposition solution was prepared by blending together 200.2 parts by weight of the resin A, 200 parts by weight of a hydroxyl group-containing acryl fluoride copolymer (AS-1301 made by Mitsubishi Rayon Co., Ltd.), 100 parts by weight of Colonate L, 1,000 parts by weight of deionized water and 2.4 parts by weight of dibutyltin laurate.

Then, dispersed in the aforesaid water-repellent acryl-epoxy electrodeposition solution was an electrically conductive material, i.e., carbon nanotubes (gas-phase process carbon fibers VGCF made by Show Denko Co., Ltd.) in an amount of 60% by weight with respect to the resin solid matter to obtain an electrodeposition solution.

While the aforesaid electrodeposition solution was held at 20° C. under agitation, the aforesaid metal substrate was dipped in that solution for a one-minute electrodeposition at an inter-electrode distance of 40 mm and a voltage of 50 V. The metal substrate was then pulled up and rinsed with purified water, after which the metal substrate was dried on a hotplate at 150° C. for 3 minutes, followed by heat curing treatment at 180° C. for 1 hour in a nitrogen atmosphere. As a result, there was a separator obtained, in which the metal substrate plus the grooves were provided thereon with a resin layer having a uniform thickness of 15 μm.

As a result of measurement as in Example 1, the contact angle of water in the resin layer of that separator was found to be 110°, indicating that there was high water repellency obtained.

### COMPARATIVE EXAMPLE 1

As in the example 3, a separator was prepared with the exception that an epoxy electrodeposition solution prepared as in Example 1 was used for the water-repellent acryl-epoxy electrodeposition solution.

As a result of measurement as in Example 1, the contact angle of water in the resin layer of that separator was found to be 60°, indicating that there was very low water repellency obtained.

### COMPARATIVE EXAMPLE 2

A metal substrate having grooves was prepared as in Example 1.

An electrically conductive material, i.e., carbon black (Vulcan XC-72 made by Cabot Co., Ltd.) was added to, and dispersed in, a colloidal solution of polytetrafluoroethylene (ND-2 made by Daikin Industries Co., Ltd.) in an amount of 75% by weight with respect to resin solid matter to obtain an electrically conductive coating material.

Then, the aforesaid conductive coating material was spray coated on the metal substrate, then heated at 80° C. for 1 hour in an infrared drying furnace, and finally heated at 380° C. for 1 hour. As a result, there was a separator obtained, wherein a resin layer was formed on the metal substrate plus the grooves.

As a result of measurement as in Example 1, the contact angle of water in the resin layer of that separator was found to be 120°, indicating that there was high water repellency obtained.

However, the resin layer of the separator was thicker than those in Examples 1-3, but all the same there was a large thickness variation. In other words, there was a pinhole-like, resin layer-free site found at the side wall in particular, which was detrimental to the reliability of the separator.

### POSSIBLE APPLICATIONS TO THE INDUSTRY

The present invention can be applied to the fabrication of a fuel cell wherein a plurality of unit cells, each having electrodes on both sides of a solid polymer electrolyte membrane, are stacked one upon another.

What is claimed is:

1. A separator for a polymer electrolyte type fuel cell, characterized by comprising a metal substrate, a groove formed in at least one surface of said metal substrate, and a resin layer formed by electrodeposition in such a way as to cover said metal substrate, wherein said resin layer contains an electrically conductive material and a water-repellent material.

2. The separator for a polymer electrolyte type fuel cell according to claim 1, wherein said electrically conductive material is at least one of a carbon particle, a carbon nanotube, a carbon nanofiber, a carbon nanohorn, and a corrosion-resistant metal.

3. The separator for a polymer electrolyte type fuel cell according to claim 1, wherein said water-repellent material is at least one of a fluorine-containing resin fine particle, a hydrocarbon resin fine particle, a fine particle of any one of a metal, inorganic compound and organic compound coated on its surface with a fluorine-containing resin or hydrocarbon resin, and a fine particle of an inorganic compound silane-treated on its surface with a silane-coupling agent.

4. The separator for a polymer electrolyte type fuel cell according to claim 1, wherein said water-repellent material has an average particle diameter ranging from 0.1 to 50 μm.

5. The separator for a polymer electrolyte type fuel- cell according to claim 1, wherein said resin layer has a thickness ranging from 0.1 to 100 μm.

6. The separator for a polymer electrolyte type fuel cell according to claim 1, wherein a part of said water-repellent material is exposed out on a surface of said resin layer.

7. A separator for a polymer electrolyte type fuel cell, characterized by comprising a metal substrate, a groove formed in at least one surface of said metal substrate, and a resin layer formed by electrolytic polymerization in such a way as to cover said metal substrate, wherein said resin layer contains a resin comprising an electrically conductive polymer and further containing a conductivity-improving dopant and a water-repellent material.

8. The separator for a polymer electrolyte type fuel cell according to claim 7, wherein said water-repellent material is at least one of a fluorine-containing resin fine particle, a hydrocarbon resin fine particle, a fine particle of any one of a metal, inorganic compound and organic compound coated on its surface with a fluorine-containing resin or hydrocarbon resin, and a fine particle of an inorganic compound silane-treated on its surface with a silane coupling agent.

9. The separator for a polymer electrolyte type fuel cell according to claim 7, wherein said water-repellent material has an average particle diameter ranging from 0.1 to 50 μm.

10. The separator for a polymer electrolyte type fuel cell according to claim 7, wherein said resin layer has a thickness ranging from 0.1 to 100 μm.

11. The separator for a polymer electrolyte type fuel cell according to claim 7, wherein a part of said water-repellent material is exposed out on a surface of said resin layer.

12. A separator for a polymer electrolyte type fuel cell, characterized by comprising a metal substrate, a groove formed in at least one surface of said metal substrate, and a resin layer formed in such a way as to cover said metal substrate, wherein said resin layer comprises a first resin layer wherein a conductivity-improving dopant and a water-repellent material are contained in a resin comprising an electrically conductive polymer formed by electrolytic polymerization, and a second resin layer formed by electrodeposition in such a way as to cover said first resin layer and containing an electrically conductive material and a water-repellent material.

13. The separator for a polymer electrolyte type fuel cell according to claim 12, wherein said electrically conductive material is at least one of a carbon particle, a carbon nanotube, a carbon nanofiber, a carbon nanohorn, and a corrosion-resistant metal.

14. The separator for a polymer electrolyte type fuel cell according to claim 12, wherein said water-repellent material is at least one of a fluorine-containing resin fine particle, a hydrocarbon resin fine particle, a fine particle of any one of a metal, inorganic compound and organic compound coated on its surface with a fluorine-containing resin or hydrocarbon resin, and a fine particle of an inorganic compound silane-treated on its surface with a silane coupling agent.

15. The separator for a polymer electrolyte type fuel cell according to claim 12, wherein said water-repellent material has an average particle diameter ranging from 0.1 to 50 μm.

16. The separator for a polymer electrolyte type fuel cell according to claim 12, wherein said resin layer has a thickness ranging from 0.1 to 100 μm.

17. The separator for a polymer electrolyte type fuel cell according to claim 12, wherein a part of said water-repellent material is exposed out on a surface of said resin layer.

18. A separator for a polymer electrolyte type fuel cell, characterized by comprising a metal substrate, a groove formed in at least one surface of said metal substrate, and a resin layer formed by electrodeposition in such a way as to cover said metal substrate, wherein said resin layer contains an electrically conductive material, and at least a portion of said resin layer positioned at said groove is covered with a water-repellent layer.

19. The separator for a polymer electrolyte type fuel cell according to claim 18, wherein said electrically conductive material is at least one of a carbon particle, a carbon nanotube, a carbon nanofiber, a carbon nanohorn, and a corrosion-resistant metal.

20. The separator for a polymer electrolyte type fuel cell according to claim 18, wherein said water-repellent layer comprises a water-repellent material contained in a binder, wherein said water-repellent material is at least one of a fluorine-containing resin fine particle, a hydrocarbon resin fine particle, a fine particle of any one of a metal, inorganic compound and organic compound coated on its surface with a fluorine-containing resin or hydrocarbon resin, and a fine particle of an inorganic compound silane-treated on its surface with a silane coupling agent.

21. The separator for a polymer electrolyte type fuel cell according to claim 18, wherein there is said water-repellent layer present on said resin layer in archipelagic configuration.

22. The separator for a polymer electrolyte type fuel cell according to claim 18, wherein said water-repellent layer has a thickness ranging from 1 to 100 nm.

23. A separator for a polymer electrolyte type fuel cell, characterized by comprising a metal substrate, a groove formed in at least one surface of said metal substrate, and a resin layer formed by electrolytic polymerization in such a way as to cover said metal substrate, wherein said resin layer comprises a resin comprising an electrically conductive polymer and further containing a conductivity-improving dopant, and at least a portion of said resin layer positioned at said groove is covered with a water-repellent layer.

24. The separator for a polymer electrolyte type fuel cell according to claim 23, wherein said water-repellent layer comprises a water-repellent material contained in a binder, wherein said water-repellent material is at least one of a fluorine-containing resin fine particle, a hydrocarbon resin fine particle, a fine particle of any one of a metal, inorganic compound and organic compound coated on its surface with a fluorine-containing resin or hydrocarbon resin, and a fine particle of an inorganic compound silane-treated on its surface with a silane coupling agent.

25. The separator for a polymer electrolyte type fuel cell according to claim 23, wherein there is said water-repellent layer present on said resin layer in archipelagic configuration.

26. The separator for a polymer electrolyte type fuel cell according to claim 23, wherein said water-repellent layer has a thickness ranging from 1 to 100 nm.

27. A separator for a polymer electrolyte type fuel cell, characterized by comprising a metal substrate, a groove formed in at least one surface of said metal substrate, and a resin layer in such a way as to cover said metal substrate, wherein said resin layer comprises a first resin layer wherein a conductivity-improving dopant is contained in a resin comprising an electrically conductive polymer formed by electrolytic polymerization, and a second resin layer formed by electrodeposition in such a way as to cover said first resin layer and containing an electrically conductive material, and at least a portion of said resin layer positioned at said groove is covered with a water-repellent layer.

28. The separator for a polymer electrolyte type fuel cell according to claim 27, wherein said electrically conductive material is at least one of a carbon particle, a carbon nanotube, a carbon nanofiber, a carbon nanohorn, and a corrosion-resistant metal.

29. The separator for a polymer electrolyte type fuel cell according to claim 27, wherein said water-repellent layer comprises a water-repellent material contained in a binder, wherein said water-repellent material is-at least one of a fluorine-containing resin fine particle, a hydrocarbon resin fine particle, a fine particle of any one of a metal, inorganic compound and organic compound coated on its surface with a fluorine-containing resin or hydrocarbon resin, and a fine particle of an inorganic compound silane-treated on its surface with a silane coupling agent.

30. The separator for a polymer electrolyte type fuel cell according to claim 27, wherein there is said water-repellent layer present on said resin layer in archipelagic configuration.

31. The separator for a polymer electrolyte type fuel cell according to claim 27, wherein said water-repellent layer has a thickness ranging from 1 to 100 nm.

32. A separator for a polymer electrolyte type fuel cell, characterized by comprising a metal substrate, a groove formed in at least one surface of said metal substrate, and a resin layer formed by electrodeposition in such a way as to cover said metal substrate, wherein said resin layer contains an electrically conductive material and has water repellency.

33. The separator for a polymer electrolyte type fuel cell according to claim 32, wherein said electrically conductive material is at least one of a carbon particle, a carbon nanotube, a carbon nanofiber, a carbon nanohorn, and a corrosion-resistant metal.

34. The separator for a polymer electrolyte type fuel cell according to claim 32, wherein said resin layer contains at least one of an element or functional group for development of water repellency.

35. The separator for a polymer electrolyte type fuel cell according to claim 32, wherein said element is fluorine and/or silicon and said functional group is an alkyl group.

36. The separator for a polymer electrolyte type fuel cell according to claim 32, wherein said resin layer has a thickness ranging from 0.1 to 100 μm.

37. A separator for a polymer electrolyte type fuel cell, characterized by comprising a metal substrate, a groove formed in at least one surface of said metal substrate, and a resin layer formed by electrolytic polymerization in such a way as to cover said metal substrate, wherein said resin layer comprises a resin comprising an electrically conductive polymer and further containing a conductivity-improving dopant, and has water repellency.

38. The separator for a polymer electrolyte type fuel cell according to claim 37, wherein said resin layer contains at least one of an element or functional group for development of water repellency.

39. The separator for a polymer electrolyte type fuel cell according to claim 37, wherein said element is fluorine and/or silicon and said functional group is an alkyl group.

40. The separator for a polymer electrolyte type fuel cell according to claim 37, wherein said resin layer has a thickness ranging from 0.1 to 100 μm.

41. A separator for a polymer electrolyte type fuel cell, characterized by comprising a metal substrate, a groove formed in at least one surface of said metal substrate, and a resin layer formed in such a way as to cover said metal substrate, wherein said resin layer comprises a first resin layer wherein a conductivity-improving dopant is contained in a resin comprising an electrically conductive polymer formed by electrolytic polymerization, and a second resin layer formed by electrodeposition in such a way as to cover said first resin layer, containing an electrically conductive material and having water repellency.

42. The separator for a polymer electrolyte type fuel cell according to claim 41, wherein said electrically conductive material is at least one of a carbon particle, a carbon nanotube, a carbon nanofiber, a carbon nanohorn, and a corrosion-resistant metal.

43. The separator for a polymer electrolyte type fuel cell according to claim 41, wherein said resin layer contains at least one of an element or functional group for development of water repellency.

44. The separator for a polymer electrolyte type fuel cell according to claim 41, wherein said element is fluorine and/or silicon and said functional group is an alkyl group.

45. The separator for a polymer electrolyte type fuel cell according to claim 41, wherein said resin layer has a thickness ranging from 0.1 to 100 μm.

46. A process for fabrication of a separator for a polymer electrolyte type fuel cell, characterized by comprising a step of forming a groove in at least one surface of a metal substrate, and a step of using an electrodeposition solution with an electrically conductive material and a water repellent material dispersed therein to form a resin layer by electrodeposition in such a way as to cover said metal substrate.

47. A process for fabrication of a separator for a polymer electrolyte type fuel cell, characterized by comprising a step of forming a groove in at least one surface of a metal substrate, and a step of forming a resin layer by electrolytic polymerization in such a way as to cover said metal substrate, wherein said resin layer comprises a resin comprising an electrically conductive polymer and further containing a conductivity-improving dopant and a water-repellent material.

48. A process for fabrication of a separator for a polymer electrolyte type fuel cell, characterized by comprising a step of forming a groove in at least one surface of a metal substrate, a step of forming a first resin layer by electrolytic polymerization in such a way as to cover said metal substrate, wherein said first resin layer comprises a resin comprising an electrically conductive polymer and further containing a conductivity-improving dopant and a water-repellent material, and a step of forming a second resin layer in such a way as to cover said first resin layer by means of electrodeposition using an electrodeposition solution with an electrically conductive material and a water-repellent material dispersed therein.

49. A process for fabrication of a separator for a polymer electrolyte type fuel cell, characterized by comprising a step of forming a groove in at least one surface of a metal substrate, a step of forming a resin layer in such a way as to cover said metal substrate by means of electrodeposition using an electrodeposition solution with an electrically conductive material dispersed therein, and a step of forming a water-repellent layer in such a way as to cover at least a portion of said resin layer positioned at said groove.

50. A process for fabrication of a separator for a polymer electrolyte type fuel cell, characterized by comprising a step of forming a groove in at least one surface of a metal substrate, a step of forming a resin layer by means of electrolytic polymerization in such a way as to cover said metal substrate, wherein said resin layer comprises a resin comprising an electrically conductive polymer and further containing a conductivity-improving dopant, and a step of forming a water-repellent layer in such a way as to cover at least a portion of said resin layer positioned at said groove.

51. A process for fabrication of a separator for a polymer electrolyte type fuel cell, characterized by comprising a step of forming a groove in at least one surface of a metal substrate, a step of forming a first resin layer in such a way as to cover said metal substrate by means of electrolytic polymerization, wherein said first resin layer comprises a resin comprising an electrically conductive polymer and further containing a conductivity-improving dopant, a step of forming a second resin layer in such a way as to cover said first resin layer by means of electrodeposition using an electrodeposition solution with an electrically conductive material dispersed therein, and a step of forming a water-repellent layer in such a way as to cover at least a portion of said second resin layer positioned at said groove.

52. A process for fabrication of a separator for a polymer electrolyte type fuel cell, characterized by comprising a step of forming a groove in at least one surface of a metal substrate, and a step of forming a water-repellent resin layer in such a way as to cover said metal substrate by electrodeposition using an electrodeposition solution wherein an electrically conductive material is dispersed in a resin having in its structure at least one of an element or functional group for development of water repellency.

53. A process for fabrication of a separator for a polymer electrolyte type fuel cell, characterized by comprising a step of forming a groove in at least one surface of a metal substrate, and a step of forming a water-repellent resin layer in such a way as to cover said metal substrate by means of electrolytic polymerization, wherein said rein layer comprises a resin comprising an electrically conductive polymer having in its structure at least one of an element or functional group for development of water repellency and further containing a conductivity-improving dopant.

54. A process for fabrication of a separator for a polymer electrolyte type fuel cell, characterized by comprising a step of forming a groove in at least one surface of a metal substrate, a step of forming a first resin layer by electrolytic polymerization in such a way as to cover said metal substrate, wherein said first resin layer comprises a resin comprising an electrically conductive polymer and further containing a conductivity-improving dopant, and a step of forming a second resin layer in such a way as to cover said first resin layer by electrodeposition using an electrodeposition solution wherein an electrically conductive material is dispersed in a resin having in its structure at least one of an element or functional group for development of water repellency.
